(19) United States
(12) Patent Application Publication
(10) Pub. No.: US 2026/0032114 A1
(43) Pub. Date: Jan. 29, 2026

(54) APPARATUS AND METHOD FOR CONTROLLING AEROSOL GENERATION

(71) Applicant: KT&G CORPORATION, Daejeon (KR)

(72) Inventor: Yong Mi JUNG, Daejeon (KR)

(73) Assignee: KT&G CORPORATION, Daejeon (KR)

(21) Appl. No.: 19/277,561

(22) Filed: Jul. 23, 2025

(30) Foreign Application Priority Data
Jul. 25, 2024 (KR) 10-2024-0098541

(51) Int. Cl. H04L 9/40; A24F 40/53; A24F 40/60

(52) U.S. Cl. CPC H04L 63/0861; A24F 40/53; A24F 40/60

(57) ABSTRACT

Disclosed herein is a generation control apparatus. The apparatus may include a first authenticator configured to perform first authentication, and a determiner configured to determine whether to operate an aerosol generator based on the result of the first authentication. The first authenticator may perform the first authentication under the condition that the second authentication has been completed. The apparatus may include an acquisition unit configured to obtain registration information required for the first authentication, and a second authenticator configured to perform the second authentication using the registration information. The second authenticator may register the registration information as reference data used for the first authentication only when the second authentication is normally performed.

### CROSS REFERENCE TO RELATED APPLICATION

This application claims priority from and the benefit of Korea Patent Application No. 10-2024-0098541, filed on 25 Jul. 2024, the disclosures of which are incorporated herein by reference in their entirety.

### BACKGROUND OF THE INVENTION

### Field of the Invention

The present disclosure relates to an apparatus and method for generating an aerosol, such as an electronic cigarette.

### Description of the Related Art

In recent years, there has been a growing demand for alternative methods that overcome the disadvantages of a conventional cigarette. For example, there is increasing interest in methods for generating aerosol by heating an aerosol-generating substance within a cigarette or a liquid reservoir, rather than by burning the cigarette to generate the aerosol.

A conventional aerosol generating apparatus operates simply in response to a user's button input. Thus, there is a problem in that unauthorized use by non-authenticated users is possible.

### SUMMARY OF THE INVENTION

The present disclosure has been made in view of the technical background as described above, and is directed to an apparatus and method for controlling aerosol generation in which adult authentication and registrant authentication are simultaneously performed through a single authentication process.

In accordance with an aspect of the present disclosure, there is provided an aerosol generation control apparatus. The aerosol generation control apparatus may include a first authenticator configured to perform first authentication, and a determiner configured to determine whether to operate an aerosol generator based on a result of the first authentication. The first authenticator may perform the first authentication under the condition that the second authentication has been completed.

The generation control apparatus may further include an acquisition unit configured to obtain registration information required for the first authentication, and a second authenticator configured to perform the second authentication using the registration information.

The second authenticator may register the registration information as reference data used for the first authentication only when the second authentication is normally performed.

Once the specific registration information is registered as the reference data, the first authenticator may perform first authentication on newly acquired registration information using the reference data regardless of whether the second authentication is performed on the newly acquired registration information.

The acquisition unit may acquire specific registration information, and the first authenticator may immediately perform the first authentication when the specific registration information matches the reference data.

The determiner may determine whether to operate the aerosol generator using only a result of the first authentication, regardless of the second authentication.

The second authenticator may not perform the second authentication when the specific registration information matches the reference data.

The generation control apparatus may include an acquisition unit configured to obtain registration information required for the first authentication, and a second authenticator configured to register the registration information as reference data used for the first authentication. In this case, the second authenticator may use the second authentication to register the reference data, and the first authenticator may perform the first authentication using the reference data registered by the second authenticator.

The first authenticator may use the first authentication to determine usage authorization of the aerosol generator.

The generation control apparatus may include an acquisition unit configured to obtain user's biometric information, and a second authenticator configured to perform adult authentication using the biometric information.

The second authenticator may register the biometric information as reference data of the first authentication when the adult authentication has been normally completed.

The generation control apparatus may include an acquisition unit configured to obtain user's biometric information. Here, the first authenticator may compare the registered reference data with the biometric information under the condition that the adult authentication is completed, and the determiner may determine whether to operate the aerosol generator based on the comparison result between the reference data and the biometric information.

The generation control apparatus may include an acquisition unit mounted on the aerosol generator, and a second authenticator mounted on the aerosol generator.

The acquisition unit may acquire user's biometric information, and the second authenticator may include a first communication module that communicates with an authentication server via a wired or wireless communication network.

The second authenticator may transmit the biometric information to the authentication server, and may request adult authentication of the biometric information from the authentication server.

When the second authenticator receives information from the authentication server indicating that adult authentication for the biometric information has succeeded, it may register the biometric information as reference data for the first authentication.

When the second authenticator receives information from the authentication server indicating that adult authentication for the biometric information has failed, it may not register the biometric information as reference data.

The first authenticator may be mounted on the aerosol generator.

The first authenticator may perform the first authentication using reference data registered by the second authenticator.

The determiner may inhibit the operation of the aerosol generator when the first authentication fails.

The generation control apparatus may include an acquisition unit mounted on the aerosol generator, and a second authenticator mounted on the aerosol generator.

The acquisition unit may acquire user's biometric information, and the second authenticator may include a second communication module configured to communicate with a user's terminal via a wired or wireless communication network.

The second authenticator may allow communication between the second communication module and the terminal, only when a serial code individually assigned to the aerosol generator is input into the terminal,

When the communication between the second communication module and the terminal is permitted, the second authenticator may transmit the biometric information to the terminal.

The second authenticator may request the terminal to perform adult authentication of the biometric information through an authentication server.

When the second authenticator receives information from the terminal indicating that adult authentication for the biometric information performed by the authentication server has succeeded, it may register the biometric information as reference data for the first authentication.

When the second authenticator receives information from the terminal indicating that adult authentication for the biometric information performed by the authentication server has failed, it may not register the biometric information as reference data.

The first authenticator may be mounted on the aerosol generator, and the first authenticator may perform the first authentication using reference data registered by the second authenticator.

The determiner may inhibit the operation of the aerosol generator when the first authentication fails.

The generation control apparatus may include a fingerprint sensor configured to recognize a user's fingerprint.

The first authenticator may perform the first authentication using fingerprint information recognized by the fingerprint sensor at an end of a preset duration when detection of the fingerprint is continuously maintained for the preset duration.

The generation control apparatus may further include a position detector configured to detect a current position of the aerosol generator, and when the determiner determines that the current position is included in a non-smoking area, the determiner may suppress an operation of the aerosol generator regardless of whether the first authentication is performed.

The position detector may be normally maintained in a state where supply of driving power is cut off.

The first authenticator may provide the driving power to the position detector, when the first authentication is normally performed.

The determiner may permit the operation of the aerosol generator only when the current position detected by the position detector, which is supplied with the driving power, is outside the non-smoking area.

An operation unit operated manually by a user may be provided.

When operation suppression of the aerosol generator due to the current position being within the non-smoking area is defined as zone-based suppression, the operation unit may forcibly release the zone-based suppression through the manual operation, only when the first authentication is normally performed.

The aerosol generator may provide a smoke menu that allows selection between a smoke mode and a smokeless mode during aerosol generation. The determiner may set the smoke menu to the smokeless mode regardless of a preset state of the smoke menu, when the zone-based suppression is forcibly released by the operation unit.

The generation control apparatus may be provided with an acquisition unit that acquires user's biometric information.

A position detector may be provided to detect the current position of the aerosol generator.

When registrant authentication using the biometric information fails, the first authenticator may transmit the current position to a preset terminal.

A generation control apparatus according to an embodiment of the present disclosure may include a first authenticator, a second authenticator, and a determiner mounted on an aerosol generator. The first authenticator may perform first authentication, the second authenticator may perform second authentication, and the determiner may distinguish between a first mode in which the first authentication is performed and a second mode in which the second authentication is performed, based on a user's selection.

In the second mode, the determiner may perform the second authentication and register reference data used for the first authentication based on a result of the second authentication.

In the first mode, the determiner may perform the first authentication using the reference data.

If the second mode is selected while the reference data is not registered, the determiner may immediately perform the second mode.

If the second mode is selected while the reference data has already been registered, the determiner may first perform the first mode while deferring execution of the second mode.

The determiner may perform the second mode when the first authentication is normally completed through execution of the first mode.

If the first mode is selected while the reference data is not registered, the determiner may first perform the second mode while deferring execution of the first mode.

If the reference data is registered through execution of the second mode, the determiner may perform the first mode that is deferred.

According to an embodiment of the present disclosure, an aerosol generation control method is disclosed. The aerosol generation control method may include an acquisition step of acquiring first biometric information in a first mode for attempting smoking using an aerosol generator, and acquiring second biometric information in the second mode for registering a user, a first authentication step of performing registrant authentication by comparing the first biometric information with previously registered reference data, in the first mode, a determination step of permitting an operation of the aerosol generator when the registrant authentication is successful, in the first mode, and a second authentication step of performing adult authentication using the second biometric information, in the second mode, and registering the second biometric information as the reference data when the adult authentication is successful.

All tobacco products (including Heat Not Burn Tobacco, liquid-type electronic cigarettes, powder inhalers, and liquid-type inhalers) are potentially less harmful to health and are inexpensive, thereby offering an accessible alternative for existing adult smokers. On the other hand, it is desirable that tobacco products be designed in a form that ensures they are out of reach of adolescents/minors.

In the case of combustible cigarettes, it is impossible to include a device that provides the corresponding environment. However, in the case of modern tobacco products that include electronic devices, it is very easy and desirable to provide various additional functions through user authentication.

A generation control apparatus of the present disclosure can present such a method.

The generation control apparatus of the present disclosure can provide an electronic cigarette that can only be used by a user who has been granted usage authorization through adult authentication and identity authentication.

According to the present disclosure, device technology capable of fulfilling the social responsibility and obligation of protecting adolescents and minors can be provided.

The generation control apparatus of the present disclosure can operate in a second mode in an initial registration step.

A user can be registered according to an identity authentication method selected in a setting step of an electronic cigarette device corresponding to an aerosol generator.

In particular, an important first step may include performing adult authentication at the time of registering biometric information, such as a fingerprint, which corresponds to registration information.

The generation control apparatus can exchange data with a fingerprint data processing server, which corresponds to an adult authentication server using resident registration number and fingerprint, when recognizing a fingerprint during user registration after the initial purchase of the device.

The authentication server can search a pre-stored database for a fingerprint that matches fingerprint information received from the generation control apparatus and can determine, confirm, or authenticate whether the person is a legal adult by analyzing the resident registration number information matching the searched fingerprint.

The authentication server can provide the result of the adult authentication to the generation control apparatus.

The generation control apparatus that receives the result of adult authentication from the authentication server can register or reject a fingerprint obtained from a user based on the result.

The fingerprint registered by the generation control apparatus can be based on the successful completion of adult authentication. Therefore, the fact that a specific fingerprint has been registered by the generation control apparatus may mean that the user of the corresponding fingerprint has been authenticated as an adult.

Once a specific fingerprint is registered, the generation control apparatus can determine whether to operate the device by determining whether the previously registered specific fingerprint and the newly acquired user's fingerprint match or are identical when the user's fingerprint is acquired later, without additional adult authentication.

According to the present disclosure, after the registration step, the device can be used immediately by simply performing general identity authentication or identity verification procedures. However, since reference data used to verify identity corresponds to specific biometric information for which adult authentication has been completed, the identity authentication performed in the present disclosure may be considered to include adult authentication.

As a result, according to the generation control apparatus of the present disclosure, minors and adolescents who are not adults cannot register biometric information and thus cannot operate the device.

On the other hand, once an adult has completed the registration of his or her biometric information, the device can be operated normally by performing only a general identity verification such procedure, as touching a fingerprint sensor, to unlock a smartphone's screen.

Therefore, the present disclosure can suppress the use of an aerosol generator by minors while minimizing adult users' discomfort in using the aerosol generator.

The generation control apparatus of the present disclosure may be mounted on an electronic cigarette device corresponding to the aerosol generator, or on a portable terminal such as a smartphone that communicates with the aerosol generator.

In an embodiment that utilizes at least a portion of a terminal, an application implementing a specific function, for example, a control app may be installed on the terminal.

The terminal on which the control app is installed may obtain the serial code of the electronic cigarette device from the user and then complete adult authentication by comparing the fingerprint with the resident registration number. The terminal may receive assistance from a separate authentication server in the adult authentication process.

The terminal may transmit the result of the adult authentication to the aerosol generator.

The aerosol generator may register a fingerprint for which adult authentication has been completed as reference data, and this fingerprint may be used as a basis for comparison with subsequently acquired fingerprints.

In addition to the fingerprint, registration information such as iris recognition and/or facial identification, and biometric information may also be used as reference data or acquired through the aerosol generator.

If the registration information of the present disclosure is a fingerprint, when a user places a hand on the fingerprint sensor, the aerosol generator may be turned on by the generation control apparatus after a set time (the reason for introducing a time delay is to prevent malfunction caused by accidental fingerprint contact) and may enter a preheating state for generating an aerosol.

When the registration information is iris recognition or facial identification, the aerosol generator controlled by the generation control apparatus is less likely to malfunction due to accidental contact, as with fingerprints. Therefore, it can be powered on immediately after recognition is completed and can enter the preheating state.

If a user is determined to be unregistered through fingerprint, iris or facial recognition, the generation control apparatus may display a message indicating that the user is not registered and then turn off the aerosol generator.

The aerosol generator may be provided with position detector that detects its position, such as a Global Positioning System (GPS).

The generation control apparatus may use the position detector to prevent a power button of the aerosol generator from operating in a legally designated non-smoking area, even if the user is registered through fingerprint, iris, or facial recognition.

However, since GPS errors may occur, an additional measure may be provided to allow only a recognized registrant to access a release button, enabling the forced use of the aerosol generator.

The aerosol generator may be provided with a switch to select between a smoke mode in which a large amount of smoke is produced and a smokeless mode in which smoke production is minimized. The generation control apparatus may be linked to the GPS, so that in the case of a non-smoking area according to GPS data, the switch may be controlled to be set to the smokeless mode by default, even if a user manually overrides the usage restriction.

In the case of a powder nicotine inhaler, the generation control apparatus can control the aerosol generator so that a powder delivery passage is not opened unless a user is authenticated.

In the case of a capsule-type device, the generation control apparatus can control the aerosol generator to prevent needle piercing from operating.

In the case of a cartridge-type device, the generation control apparatus can control the aerosol generator so that the flow passage of a mouthpiece is closed.

### BRIEF DESCRIPTION OF THE DRAWINGS

FIG. 1 is a schematic diagram illustrating a generation control apparatus according to an embodiment of the present disclosure.

FIG. 2 is a schematic diagram illustrating an operation of the generation control apparatus according to an embodiment of the present disclosure.

FIG. 3 is a flowchart illustrating a generation control method according to an embodiment of the present disclosure.

FIG. 4 is a schematic diagram illustrating an aerosol generator.

FIG. 5 is a perspective view illustrating an aerosol generator to which the generation control apparatus according to an embodiment of the present disclosure is applied.

FIG. 6 is a diagram illustrating a computing device according to an embodiment of the present disclosure.

### DETAILED DESCRIPTION OF THE INVENTION

Embodiments of the present disclosure will be described below in detail with reference to the accompanying drawings so that those skilled in the art can easily carry out the disclosure. The present disclosure may, however, be embodied in many different forms and should not be construed as being limited to only the embodiments set forth herein. In addition, parts that are not relevant to the description have been omitted from the drawings for the sake of clarity, and like reference numerals are used throughout the specification to designate like components.

Herein, redundant descriptions of identical components are omitted.

It will be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present.

The terminology used herein is for the purpose of describing specific embodiments only and is not intended to limit the scope of the disclosure.

As used herein, the singular forms “a”, “an” and “the” are intended to include the plural forms as well, unless the context clearly indicates otherwise.

In this specification, terms such as “comprises”, “includes”, or “have/has” should be construed as designating that there are such features, integers, steps, operations, components, parts, and/or combinations thereof, not to exclude possibility of the presence or addition of one or more of other features, integers, steps, operations, components, parts, and/or combinations thereof.

In this specification, the term “and/or” includes the combination of the listed items as well as any one of the listed items. In this specification, the term “A or B” may include “A”, “B” or “both A and B”.

Further, in this specification, the detailed description of known functions and configurations that may obscure the gist of the present disclosure will be omitted.

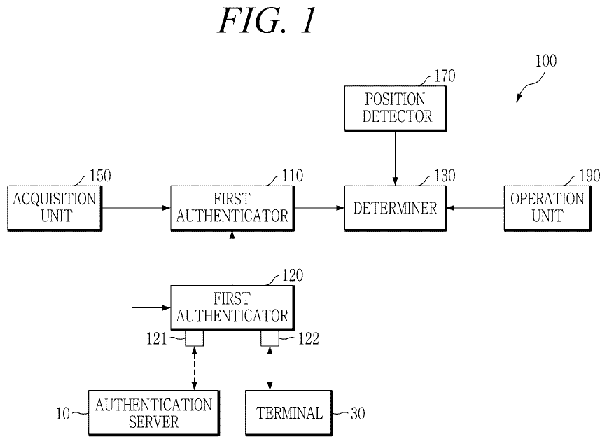

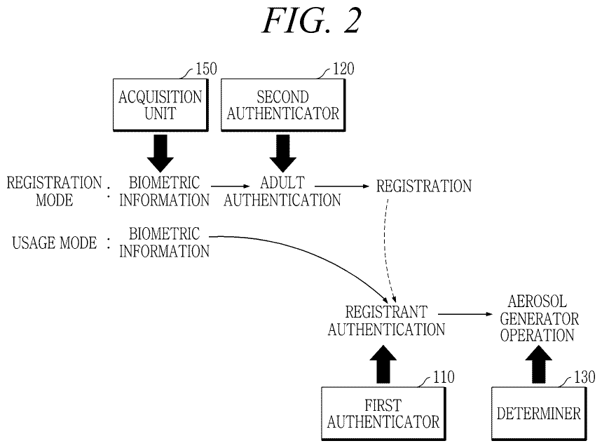

FIG. 1 is a schematic diagram illustrating a generation control apparatus 100 according to an embodiment of the present disclosure. FIG. 2 is a schematic diagram illustrating an operation of the generation control apparatus 100 according to an embodiment of the present disclosure.

The generation control apparatus 100 shown in FIG. 1 may include an acquisition unit 150, a first authenticator 110, a second authenticator 120, and a determiner 130.

The acquisition unit 150 may acquire registration information required for first authentication or second authentication.

The first authenticator 110 may perform the first authentication.

The second authenticator 120 may perform the second authentication.

The determiner 130 may determine whether to operate an aerosol generator 200 based on the result of the first authentication.

At this time, the first authenticator 110 may perform the first authentication under the condition that the second authentication has been completed. In other words, when the second authentication is not completed (incomplete), the first authentication may not be performed (not performed). Alternatively, the first authentication may be normally performed only when the second authentication has been completed. That is, herein, the expression “the first authentication is performed” may mean that the second authentication has already been normally completed.

For example, the first authentication may be identity authentication or user authentication, or registrant authentication, which verifiers that the user is an actual user or a registered individual. The second authentication may include adult authentication proving that a user is above a specified age.

The registration information may include biometric information, password information, secret pattern information, etc.

The biometric information may include at least one of fingerprint recognition information, facial recognition information, iris recognition information, vein recognition information, voice recognition information, and palm print recognition information.

When the acquisition unit 150 acquires registration information required for the first authentication, the second authenticator 120 may perform the second authentication using the corresponding registration information. For example, a user may perform fingerprint recognition to operate the aerosol generator 200 such as an electronic cigarette. The fingerprint recognition may be used for so-called identity authentication, user authentication, or registrant authentication to release a lock state.

The corresponding fingerprint recognition information is acquired through the acquisition unit 150, and the second authenticator 120 may perform the second authentication, for example, the adult authentication, using the corresponding fingerprint recognition information.

The second authenticator 120 may register the registration information as reference data used for the first authentication only when the second authentication is normally performed.

Once specific registration information, for example, biometric information of user a is registered as reference data, the first authenticator 110 may then perform the first authentication on newly acquired registration information using the previously registered reference data, regardless of whether the second authentication is performed on the newly acquired registration information.

According to this embodiment, when the user a's biometric information is acquired, the second authenticator 120 may use the user a's biometric information to determine whether the user a is an adult. When it is authenticated that the user a is the adult, the user a's biometric information may be registered as the reference data. For example, when there is no registered reference data or the apparatus is in a reference data registration mode, the first authentication by the first authenticator 110 may not be performed and the second authentication by the second authenticator 120 may be performed.

After the user a's biometric information is registered as the reference data, if biometric information from an unidentified user (including user a) is newly acquired, the second authentication may not be performed on the newly acquired biometric information. Instead, the first authenticator 110 may perform the first authentication by comparing the previously registered reference data with the newly acquired biometric information.

In other words, if the reference data of user a has been registered, the first authenticator 110 may perform the first authentication using the reference data immediately upon acquiring new registration information, without performing the second authentication on the newly acquired registration information.

From another perspective, when the acquisition unit 150 acquires specific registration information, the first authenticator 110 may immediately perform the first authentication if the specific registration information matches the reference data.

The determiner 130 may determine whether to operate the aerosol generator 200 using only the result of the first authentication, regardless of the second authentication. At this time, the second authenticator 120 may not perform the second authentication when the specific registration information matches the reference data.

At least one of the acquisition unit 150, the first authenticator 110, the second authenticator 120, and the determiner 130 may be operated by the user in either a first mode or a second mode.

At this time, the first mode corresponds to a usage mode, in which the first authentication may be performed. The usage mode may be an operation mode for unlocking the aerosol generator 200 and allowing smoking.

The second mode corresponds to a registration mode, in which the second authentication may be performed. The registration mode may be an operation mode for registering a user of the aerosol generator 200 before use.

In summary, the acquisition unit 150 may acquire registration information required for the first authentication. The second authenticator 120 may register the registration information as reference data used for the first authentication. The second authenticator 120 may use the second authentication for registering the reference data.

For example, when the acquisition unit 150 acquires the user's biometric information, the second authenticator 120 may perform the adult authentication using the corresponding biometric information. When the adult authentication is normally completed, the second authenticator 120 may register the biometric information as the reference data for the first authentication.

The first authenticator 110 may perform the first authentication using the reference data that is registered by the second authenticator 120.

The first authenticator 110 may use the first authentication to determine the usage authorization of the aerosol generator 200.

The first authenticator 110 may compare the registered reference data with the biometric information under the condition that the adult authentication is completed. The adult authentication may be performed by the second authenticator 120. When the adult authentication is normally completed by the second authenticator 120, the registration information used for the adult authentication may be registered as the reference data. The first authenticator 110 may compare the registered reference data with the biometric information.

The determiner 130 may determine whether to operate the aerosol generator 200 based on the comparison result between the reference data and the biometric information. For example, when the determiner 130 determines that the reference data and the biometric information match each other, it may unlock the aerosol generator 200, and operate the aerosol generator 200 or convert it to an operable state.

At least one of the acquisition unit 150, the first authenticator 110, the second authenticator 120, and the determiner 130 described above may be installed in thee aerosol generator 200. Alternatively, when a terminal 30 communicating with the aerosol generator 200 is provided, at least one of the acquisition unit 150, the first authenticator 110, the second authenticator 120, and the determiner 130 may be installed in the terminal 30.

When the acquisition unit 150, the first authenticator 110 and/or the second authenticator 120 are installed in the aerosol generator 200, the second authenticator 120 may include a first communication module 121 that communicates with the authentication server 10 via a wired or wireless communication network.

The second authenticator 120 may transmit the biometric information acquired through the acquisition unit 150 to the authentication server 10, and request adult authentication of the biometric information from the authentication server 10. For example, the authentication server 10 may store the user's biometric information and the user's birth date information in a matching state. When the authentication server 10 receives the biometric information and adult authentication request information from the second authenticator 120, it may search database for information that matches the biometric information received from the second authenticator 120. If matching biometric information is found, the authentication server 10 may extract birth date information, such as a resident registration number, stored together with the biometric information, and determine whether the user is an adult based on that information. The authentication server 10 may transmit the result of the adult authentication to the second authenticator 120. The minimum age required to qualify as an adult may vary depending on the country or system.

When the second authenticator 120 receives information from the authentication server 10 indicating that adult authentication for the biometric information has succeeded, it may register the biometric information as reference data for the first authentication. When the second authenticator 120 receives information from the authentication server 10 indicating that adult authentication for the biometric information has failed, it may not register the biometric information as reference data.

The first authenticator 110 may perform the first authentication using the reference data registered by the second authenticator 120.

When the first authentication fails, the determiner 130 may inhibit the operation of the aerosol generator 200. This may prevent situations in which reference data is registered by a minor or the aerosol generator 200 is used by a minor.

The above embodiment may provide an environment in which the second authenticator 120 directly communicates with the authentication server 10 that substantially performs the second authentication. Since the authentication server 10 is located remotely from the aerosol generator 200, the first communication module 121 communicating with the authentication server 10 may employ a communication network such as a mobile communication network or a low-power wide-area network.

Alternatively, an embodiment may be provided in which the second authentication is performed using a short-range communication network, such as Bluetooth.

For example, when the acquisition unit 150, the first authenticator 110, and/or the second authenticator 120 are installed in the aerosol generator 200, the second authenticator 120 may include a second communication module 122 that communicates with the user's terminal 30 via the wired or wireless communication network.

The second authenticator 120 may allow communication between the second communication module 122 and the terminal 30 only when a serial code individually assigned to the aerosol generator 200 is input into the terminal 30.

Once communication between the second communication module 122 and the terminal 30 is allowed, the second authenticator 120 may transmit the biometric information to the terminal 30.

The second authenticator 120 may request the terminal 30 to perform the adult authentication of the biometric information through the authentication server 10. The terminal 30 may include a mobile communication terminal such as a smartphone used by the user. When the terminal 30 receives the biometric information and an adult authentication (which corresponds to the second authentication) request of the biometric information from the second authenticator 120, the terminal may transmit the biometric information and the adult authentication request information to the authentication server 10. The authentication server 10 may perform the adult authentication of the biometric information and transmit the result of the adult authentication to the terminal 30. The terminal 30 may transmit the result of the adult authentication received from the authentication server 10 to the second authenticator 120.

When the second authenticator 120 receives, from the terminal 30, information indicating that the adult authentication of the biometric information performed by the authentication server 10 is successful, it may register the biometric information transmitted to the terminal 30 as the reference data for the first authentication.

When the second authenticator 120 receives, from the terminal 30, information indicating that the adult authentication of the biometric information performed by the authentication server 10 fails, it may not register the biometric information transmitted to the terminal 30 as the reference data.

Once the reference data is registered, the first authenticator 110 may perform the first authentication using the reference data registered by the second authenticator 120.

The determiner 130 may suppress the operation of the aerosol generator 200 when the first authentication fails.

Meanwhile, a fingerprint sensor for recognizing a user's fingerprint may be provided in the acquisition unit 150. The fingerprint sensor may be provided in the aerosol generator 200. The aerosol generator 200 may be manufactured to be portable so that it may be carried in a pocket. In this case, the fingerprint sensor formed on the outer surface of the aerosol generator 200 may malfunction due to unintentional touches by the user when placed in the pocket. If the aerosol generator 200 operates inside the pocket due to such touches, various safety accidents may occur.

In order to prevent this problem from occurring, the first authenticator 110 may perform the first authentication using the fingerprint information recognized by the fingerprint sensor at the end of a preset duration, provided that the fingerprint detection is continuously maintained for the preset duration. For example, if the preset duration is 3 seconds, the first authentication may be performed using the fingerprint information acquired and recognized at a point in time when 3 seconds have elapsed, provided that the fingerprint information is continuously acquired through the fingerprint sensor without interruption for 3 seconds. The user may move the finger after touching the fingerprint sensor with his or her finger, causing a slight change in position for a preset duration. In this case, the fingerprint information acquired over the 3-second preset duration may vary. At this time, an issue may arise regarding which fingerprint information, acquired at what point in time, should be used for the first authentication. In the present disclosure, considering a situation where the user initially recognizes that he or she incorrectly places his or her finger on the fingerprint sensor and corrects the position of the finger, the first authentication may be performed using the fingerprint information recognized at the end of the preset duration (i.e., at the point in time when 3 seconds have elapsed).

Meanwhile, it may be necessary to impose usage restrictions on the aerosol generator 200 not only based on the user's age but also based on the place or position. For example, the use of the aerosol generator 200 should be restricted in indoor areas, hospitals, or non-smoking areas.

In this way, user convenience can be improved by automatically enforcing usage restrictions based on the place or position.

In order to impose usage restrictions based on the place or position, a position detector 170 may be further provided to identify a current position of the aerosol generator 200.

At this time, when the determiner 130 determines that the current position is included in a non-smoking area, it may suppress the operation of the aerosol generator 200 regardless of whether the first authentication is performed.

The position detector 170 may include a satellite navigation system such as a Global Positioning System (GPS) to accurately determine the current position of the aerosol generator 200. The satellite navigation system may be mounted on the aerosol generator 200 and driven using power supplied by a battery installed in the aerosol generator 200.

The battery installed in the aerosol generator 200 may have a very limited capacity due to size constraints. Since the satellite navigation system such as a GPS receiver consumes a significant amount of power, the usage time of the aerosol generator 200 may be reduced to less than a day according to the position detector 170. To extend the usage time of the aerosol generator 200, it is advantageous for the position detector 170 to be appropriately turned on and off. To this end, the power supply to the position detector 170 may be determined by the first authenticator 110.

As an example, the position detector 170 may normally remain in a state where the supply of driving power is cut off. Accordingly, the power consumption of the position detector 170 may be normally close to zero.

The first authenticator 110 may supply driving power to the position detector 170 when the first authentication is normally performed.

The determiner 130 may permit the operation of the aerosol generator 200 only when the current position identified by the position detector 170, which is supplied with driving power, is outside a non-smoking area. Further, the determiner 130 may stop or prohibit the operation of the aerosol generator 200 when the current position identified by the position detector 170, which is supplied with driving power, corresponds to a non-smoking area.

According to this embodiment, driving power may be supplied to the position detector 170 only when the first authentication is normally performed. Thus, if the first authentication is not performed, power supply to the position detector may be cut off, and the power consumption by the position detector 170 may be minimized.

Meanwhile, due to the position error of the satellite navigation system, there may be a situation where a position is incorrectly identified as a non-smoking area even though it is not. In this case, it is desirable to provide a means to forcibly override the operation restriction due to the incorrect identification of the non-smoking area.

When the user attempts the first authentication to use the aerosol generator 200 at a specific position and the first authentication is successfully completed, the position detector 170 may be operated. When a current position is identified as the non-smoking area, the position detector 170 may notify the user of a current situation by providing a message indicating that the current position is the non-smoking area, for example, through an alarm or a warning message on a display. When the user becomes aware that the current position is recognized as the non-smoking area by the position detector 170, he or she may check the surroundings to verify whether it is the non-smoking area. When it is confirmed to be the non-smoking area, the user may move out of the non-smoking area, perform the first authentication again, and use the aerosol generator 200. On the other hand, if it is determined that the current position is not the non-smoking area, the user may assume that an error has occurred in the position detector 170 and wish to use the aerosol generator 200 at the current position.

The generation control apparatus 100 may be provided with an operation unit 190 that is manually operated by the user.

The operation suppression of the aerosol generator 200 due to the current position being within the non-smoking area will be defined as zone-based suppression. In this case, the operation unit 190 may forcibly release the zone-based suppression through manual operation, only when the first authentication is normally performed.

The position detector 170 may be operated in a state where the first authentication is already performed. Thereafter, if the operation unit 190 is manipulated while a message indicating that the current position is the non-smoking area is displayed on the position detector 170, the zone-based suppression may be forcibly released. In some cases, additional first authentication may be required after the operation unit 190 is manipulated.

The specific aerosol generator 200 may provide a smoke menu that allows selection between a smoke mode and a smokeless mode during aerosol generation. For example, the aerosol generator 200 may be provided with a switch that allows the user to select between the smoke mode and the smokeless mode. The smoke mode may be an operation mode that generates visible smoke, such as white smoke. The smokeless mode may be an operation mode that does not generate smoke or suppresses the generation of smoke.

The determiner 130 may set the smoke menu to the smokeless mode regardless of the preset state of the smoke menu, when the zone-based suppression is forcibly released by the operation unit 190. The fact that the zone-based suppression is applied may indicate that the non-smoking area exists near the current position, even if there is a positional error. Therefore, in this case, the smokeless mode may be forcibly set to prevent smoke generated by smoking through the operation unit 190 from encroaching on the non-smoking area.

Meanwhile, the position detector 170 may also initiate the operation when the first authentication by the first authenticator 110 fails, that is, when registrant authentication, identity authentication and/or user authentication fails. For example, this mode may be selected and used in relation to a loss situation.

If the first authenticator 110 fails to perform registrant authentication using the biometric information (corresponding to the first authentication, performed by comparing the reference data with the biometric information), it may transmit the current position to a preset terminal 30.

This assumes a case where a lost aerosol generator 200 is used by another person. According to this embodiment, the current position of the aerosol generator 200 may be notified to the user.

A user who recognizes the loss of the aerosol generator 200 may search for the aerosol generator 200 by retracing a path where he or she has traveled. Since the aerosol generator 200 will be located along the retraced path, the user may find the lost aerosol generator 200 unless it has been taken away by another person. However, if another person moves away while carrying the aerosol generator 200, it will deviate from the retraced path and the user will not be able to find the aerosol generator 200. In such a state, if another person touches the fingerprint sensor or the like for various reasons, the first authentication fails, and the current position of the aerosol generator 200 may be transmitted to the user's terminal 30. Upon receiving the current position information, the user may move to find the aerosol generator 200.

According to the generation control apparatus 100 described above, the acquisition unit 150, the first authenticator 110, the second authenticator 120, the determiner 130, the position detector 170 and/or the operation unit 190 may be installed in the aerosol generator 200.

The first authenticator 110 may perform the first authentication, and the second authenticator 120 may perform the second authentication.

The determiner 130 may distinguish between a first mode in which the first authentication is performed and a second mode in which the second authentication is performed, based on the user's selection. In the second mode, the determiner 130 perform may the second authentication and register reference data to be used for the first authentication based on the result of the second authentication. In the first mode, the determiner 130 may perform the first authentication using the reference data.

If the second mode is selected while the reference data is not registered, the determiner 130 may immediately perform the second mode.

If the second mode is selected while the reference data has already been registered, the determiner 130 may first perform the first mode while deferring the execution of the second mode. The determiner 130 may perform the second mode when the first authentication is normally completed through the execution of the first mode.

According to second the mode, after the registration information of a first user is registered as first reference data, the registration information of a second user may be registered as second reference data. In this case, both the first user and the second user are authorized to use the aerosol generator 200. It is preferable that the second user be registered with the permission of the first user. At this time, the permission of the first user may be obtained through the first authentication of the first user after the registration of the first reference data. Once the first authentication of the first user is completed, additional registration information of the first user (such as fingerprint information of a different finger than the specific finger used for the first reference data) or registration information of the second user may be newly registered as the second reference data.

Meanwhile, if the first mode is selected while the reference data is not registered, the determiner 130 may first perform the second mode while deferring the execution of the first mode. Once the reference data is registered through the execution of the second mode, the determiner 130 may perform the first mode that is deferred. During the initial use, the user may go through a process of registering registration information as reference data. When the registration of the reference data is completed, the aerosol generator 200 may be operated immediately without the need for additional first authentication.

The fact that the user who initially purchases the aerosol generator 200 selects the first mode may be interpreted as an intention to use the aerosol generator 200 at the current time. However, since there is no reference data required to execute the first mode, the process of registering the reference data through the second authentication may be performed first. To perform the second authentication, it is possible to cancel the first mode, select the second mode again, and then perform the second authentication, but this may be inconvenient for the user. Therefore, in an initial state where there is no initial data at all, when the first mode is selected, the second mode is automatically executed instead of the first mode and the reference data may be registered (registration is possible only when the second authentication is normally passed). User convenience can be maximized by allowing the aerosol generator 200 to operate immediately after the reference data is registered, without requiring additional first authentication.

Accordingly, during initial use, if the first mode is selected and the registration information such as a fingerprint is entered once, the reference data may be automatically registered, and the aerosol generator 200 may operate immediately.

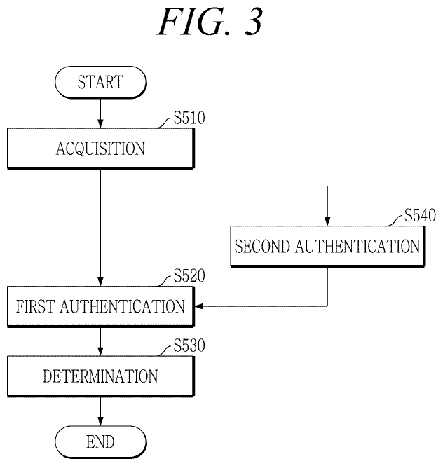

FIG. 3 is a flowchart illustrating a method for controlling generation according to an embodiment of the present disclosure.

The generation control method of FIG. 3 may be performed by the generation control apparatus 100 illustrated in FIG. 1.

The generation control method may include an acquisition step S510, a first authentication step S520, a determination step S530, and a second authentication step S540.

The acquisition step S510 may acquire first biometric information in the first mode for attempting smoking using the aerosol generator 200, and acquire second biometric information in the second mode for registering a user. The acquisition step S510 may be performed by the acquisition unit 150.

The first authentication step S520 may perform registrant authentication by comparing the first biometric information with previously registered reference data in the first mode, for example, the usage mode. The first authentication step S520 may be performed by the first authenticator 110.

The determination step S530 may allow the operation of the aerosol generator 200 if the registrant authentication is successful, in the first mode. The determination step S530 may be performed by the determiner 130.

The second authentication step S540 performs adult authentication using the second biometric information in the second mode, and may register the second biometric information as the reference data if the adult authentication is successful. The second authentication step S540 may be performed by the second authenticator 120.

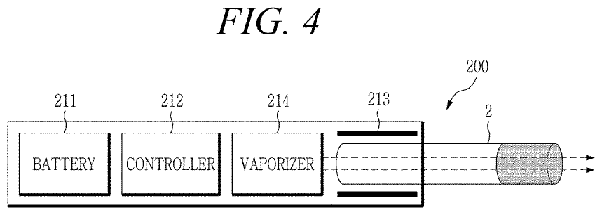

FIG. 4 is a schematic diagram illustrating the aerosol generator 200.

The aerosol generator 200 may include a battery 211, a controller 212, a vaporizer 214, and a heater 213. The heater 213 may be omitted. The generation control apparatus 100 of the present disclosure is mounted on the aerosol generator 200, and may be formed integrally with the controller 212 or formed separately from the controller 212.

The aerosol generator 200 further includes the vaporizer 214. In addition, an aerosol raw material such as a cigarette 2 may be inserted, injected, or stored in the internal space of the aerosol generator 200.

Depending on the design of the aerosol generator 200, the arrangement of the battery 211, controller 212, heater 213, and vaporizer 214 may be changed.

When the cigarette 2 is inserted into the aerosol generator 200, the aerosol generator 200 may generate an aerosol by operating the heater 213 and/or the vaporizer 214. The aerosol generated by the heater 213 and/or vaporizer 214 passes through the cigarette 2 and is delivered to the user.

If necessary, the aerosol generator 200 may heat the heater 213 even when the cigarette 2 is not inserted into the aerosol generator 200.

The battery 211 supplies power used to operate the aerosol generator 200. For example, the battery 211 may supply power to heat the heater 213 or the vaporizer 214, and may supply power necessary for the controller 212 or the generation control apparatus 100 to operate. Further, the battery 211 may supply power necessary for the operation of the display, sensor, motor, etc. installed in the aerosol generator 200.

The controller 212 controls the overall operation of the aerosol generator 200. Specifically, the controller 212 controls the operation of the battery 211, heater 213, and vaporizer 214 as well as other components included in the aerosol generator 200. Further, the controller 212 may check the status of each component of the aerosol generator 200 to determine whether the aerosol generator 200 is operable.

The controller 212 includes at least one processor. The processor may be implemented as an array of a plurality of logic gates, or may be implemented as a combination of a general-purpose microprocessor and a memory storing a program that may be executed on the microprocessor. Further, it will be understood by those skilled in the art that the present disclosure may be implemented in other forms of hardware.

The heater 213 may be heated by power supplied from the battery 211. For example, when the cigarette 2 is inserted into the aerosol generator 200, the heater 213 may be located on the outside of the cigarette. Therefore, the heated heater 213 may increase the temperature of the aerosol generating material inside the cigarette.

The heater 213 may be an electrically resistive heater. For example, the heater 213 may include an electrically conductive track, and the heater 213 may be heated as current flows through the electrically conductive track. However, the heater 213 is not limited to the above-described example, and may be used without limitation as long as it may be heated to a desired temperature. Here, the desired temperature may be preset in the aerosol generator 200, or may be set to a desired temperature by the user.

Meanwhile, as another example, the heater 213 may be an induction heating heater. Specifically, the heater 213 may include an electrically conductive coil for inductively heating the cigarette, and the cigarette may include a susceptor that may be heated by the inductive heating heater.

For example, the heater 213 may include a tubular heating element, a plate-shaped heating element, a needle-shaped heating element, or a rod-shaped heating element, and may heat the inside or the outside of the cigarette 2 depending on the shape of the heating element.

Further, a plurality f heaters 213 may be arranged in the aerosol generator 200. At this time, the plurality of heaters 213 may be arranged to be inserted into the inside of the cigarette 2 or may be arranged on the outside of the cigarette 2. In addition, some of the plurality of heaters 213 may be positioned to be inserted into the inside of the cigarette 2, while the rest may be positioned outside the cigarette 2. In addition, the heater 213 may be manufactured in various shapes without being limited to the shape shown in the drawing.

The vaporizer 214 may heat a liquid composition to generate an aerosol, and the generated aerosol may be delivered to the user through the cigarette 2. In other words, the aerosol generated by the vaporizer 214 may move along the airflow passage of the aerosol generator 200, and the airflow passage may be configured to allow the aerosol generated by the vaporizer 214 to pass through the cigarette and be delivered to the user.

For example, the vaporizer 214 may include, but is not limited to, a liquid reservoir, a liquid delivery means, and a heating element. For example, the liquid reservoir, the liquid delivery means, and the heating element may be included in the aerosol generator 200 as independent modules.

The liquid reservoir may store a liquid composition. For example, the liquid composition may be a liquid containing a tobacco-containing substance that includes a volatile tobacco flavor component, or may be a liquid containing a non-tobacco substance. The liquid reservoir may be configured to be detachable from/attachable to the vaporizer 214, or may be integrally formed with the vaporizer 214.

For example, the liquid composition may contain water, solvent, ethanol, plant extracts, flavorings, flavor agents, or vitamin mixtures. The flavorings may include, but are not limited to, menthol, peppermint or spearmint oil, and various fruit-flavored components. The flavor agent may include components that may provide a variety of flavors or tastes to the user. The vitamin mixture may be a mixture of at least one of, but is not limited to, vitamin A, vitamin B, vitamin C, and vitamin E. Further, the liquid composition may include an aerosol former such as glycerin and propylene glycol.

A liquid transfer means may transfer the liquid composition from the liquid reservoir to a heating element. For example, the liquid transfer means may be, but is not limited to, a wick such as cotton fibers, ceramic fibers, glass fibers, or porous ceramics.

The heating element is an element for heating the liquid composition delivered by the liquid transfer means. For example, the heating element may be, but is not limited to, a metal heating wire, a metal heating plate, or a ceramic heater. Further, the heating element may be composed of a conductive filament, such as a nichrome wire, and may be arranged in a structure that is wound around the liquid transfer means. The heating element may be heated by a current supply and may transfer heat to the liquid composition in contact with the heating element, thereby heating the liquid composition. As a result, an aerosol may be generated.

For example, the vaporizer 214 may be referred to as, but is not limited to, a cartomizer or an atomizer.

Meanwhile, the aerosol generator 200 may further include general-purpose components in addition to the battery 211, the controller 212, the heater 213, and the vaporizer 214. For example, the aerosol generator 200 may include a display for outputting visual information and/or a motor for outputting tactile information. Further, the aerosol generator 200 may include at least one sensor (such as a puff detecting sensor, a temperature detecting sensor, or a cigarette insertion detecting sensor). In addition, the aerosol generator 200 may be configured such that external air may be introduced or internal gas may be discharged even when the cigarette 2 is inserted.

The aerosol generator 200 may be configured as part of a system together with a separate cradle. For example, the cradle may be used to charge the battery 211 of the aerosol generator 200. Alternatively, the heater 213 may be heated while the cradle and the aerosol generator 200 are in a coupled state.

The cigarette 2 may be similar to a typical combustible cigarette. For example, the cigarette 2 may be divided into a first part containing an aerosol-generating substance and a second part including a filter or the like. Alternatively, the second part of the cigarette 2 may also contain the aerosol-generating substance. For example, the aerosol-generating substance in the form of granules or capsules may be inserted into the second part.

The entire first part may be inserted into the aerosol generator 200, and the second part may be exposed to the outside. Alternatively, only a portion of the first part may be inserted into the aerosol generator 200, and the entire first part and only a portion of the second part may be inserted. The user may inhale the aerosol while holding the second part in his or her mouth. In this case, the aerosol is generated as external air passes through the first part, and the generated aerosol passes through the second part and then is delivered to the user's mouth.

As an example, external air may be introduced through at least one air passage formed in the aerosol generator 200.

For example, the opening and closing of the air passage formed in the aerosol generator 200 and/or the size of the air passage may be adjusted by the user. Thus, the amount of aerosol or the smoking sensation may be adjusted by the user. In another example, external air may be introduced into the interior of the cigarette 2 through at least one hole formed on the surface of the cigarette 2.

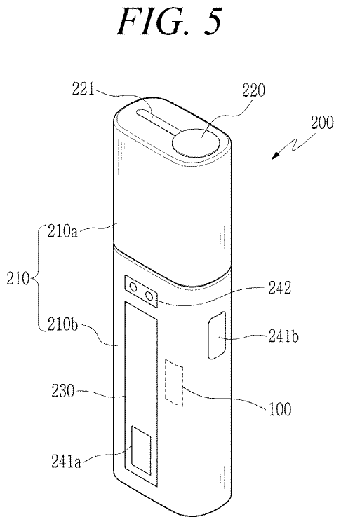

FIG. 5 is a perspective view illustrating the aerosol generator 200 to which the generation control apparatus 100 according to an embodiment of the present disclosure is applied.

The aerosol generator 200 may include a case 210 into which an aerosol-generating substrate such as the cigarette 2 may be inserted.

The case 210 may include an upper case 210a and a lower case 210b. The upper case 210a may be detachably coupled to the lower case 210b. According to an embodiment, the upper case 210a and the lower case 210b may have an integrated structure in which they are coupled to each other.

A cover 220 may be disposed on the upper case 210a. The cover 220 may slide along the upper surface of the upper case 210a. However, the movement method of the cover 220 is not limited to the sliding method. The cover 220 may be opened or closed not only by a non-rotating method such as sliding, but also by a rotating method such as tilting or hinging.

The upper case 210a may include a guide groove 221 extending along the sliding direction of the cover 220 and a cavity into which the aerosol-generating substrate is inserted. The guide groove 221 may penetrate through the upper case 210a, connecting the exterior and interior thereof.

The cover 220 may slide along the guide groove 221 between a first position that closes the cavity and a second position that opens the cavity. The driving force of the cover 220 may be provided by various actuators. Alternatively, the cover 220 may be moved between the first and second positions by manual operation of the user.

The aerosol-generating substrate inserted into the cavity may be heated by the heater.

The aerosol generator 200 may be provided with at least one of an optical fingerprint sensor 241a or a capacitive fingerprint sensor 241b to acquire the user's biometric information. The fingerprint sensor may correspond to the acquisition unit. Alternatively, the fingerprint sensor may communicate with the acquisition unit and transmit the acquired fingerprint information to the acquisition unit.

The optical fingerprint sensor 241a may be disposed on the display 230. For example, the optical fingerprint sensor 241a may be formed integrally with the display 230. The capacitive fingerprint sensor 241b may be disposed on a side of the lower case 210b.

The aerosol generator 200 may include a camera 242 to obtain the user's biometric information. The camera 242 may acquire at least one of the user's iris and face and transmit it to the controller.

The generation control apparatus 100 may transmit the result of the first authentication using the biometric information to the controller 212, and the controller 212 may open or close the cover 220 depending on whether the first authentication is successful. The generation control apparatus 100 may be formed integrally with the controller 212.

The aerosol generator 200 may include a display 230. The display 230 may indicate the operating status of the aerosol generator 200, a remaining battery level, the smoking information of an authenticated user, the success or failure of the first authentication, or the success or failure of the registration of reference data based on the second authentication.

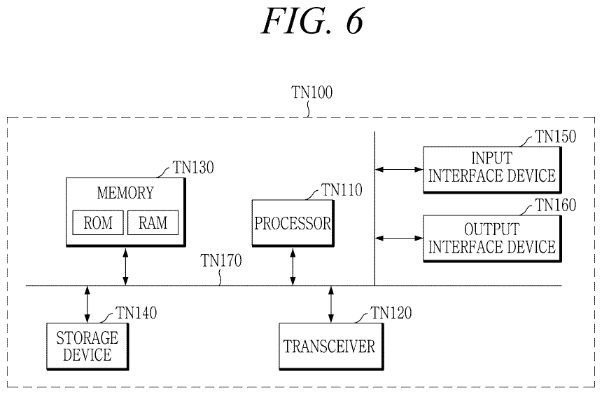

FIG. 6 is a diagram illustrating a computing device according to an embodiment of the present disclosure. A computing device TN100 of FIG. 6 may correspond to a device described herein (e.g., the generation control apparatus 100, the terminal 30, the server 10, etc.).

In the embodiment of FIG. 6, the computing device TN100 may include at least one processor TN110, a transceiver TN120, and a memory TN130. The computing device TN100 may further include a storage device TN140, an input interface device TN150, an output interface device TN160, etc. The components included in the computing device TN100 may be connected via a bus TN170 to communicate with each other.

The processor TN110 may execute a program command stored in at least one of the memory TN130 and the storage device TN140. The processor TN110 may mean a central processing unit CPU, a graphics processing unit GPU, or a dedicated processor on which methods according to embodiments of the present disclosure are performed. The processor TN110 may be configured to implement procedures, functions, methods, etc. described in connection with embodiments of the present disclosure. The processor TN110 may control each component of the computing device TN100.

Each of the memory TN130 and the storage device TN140 may store various information related to the operation of the processor TN110. Each of the memory TN130 and the storage device TN140 may be composed of at least one of a volatile storage medium and a non-volatile storage medium. For example, the memory TN130 may be composed of at least one of read-only memory (ROM) and random access memory (RAM).

The transceiver TN120 may transmit or receive wired or wireless signals. The transceiver TN120 may be connected to a network to perform communications.

Meanwhile, embodiments of the present disclosure are not limited to being implemented only through the apparatus and/or method described above. The embodiments of the present disclosure may also be implemented through a program that realizes the functions corresponding to the configuration of the embodiments or through a recording medium on which the program is recorded. Such implementations may be readily carried out by those skilled in the art based on the description of the foregoing embodiments.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A generation control apparatus, comprising:
a first authenticator configured to perform first authentication; and
a determiner configured to determine whether to operate an aerosol generator based on a result of the first authentication,
wherein the first authenticator performs the first authentication under the condition that the second authentication has been completed.

2. The generation control apparatus of claim 1, further comprising:
an acquisition unit configured to obtain registration information required for the first authentication; and
a second authenticator configured to perform the second authentication using the registration information,
wherein the second authenticator registers the registration information as reference data used for the first authentication only when the second authentication is normally performed,
wherein the acquisition unit acquires specific registration information,
wherein the first authenticator immediately performs the first authentication when the specific registration information matches the reference data, and
wherein the determiner determines whether to operate the aerosol generator using only a result of the first authentication, regardless of the second authentication.

3. The generation control apparatus of claim 1, further comprising:
an acquisition unit configured to obtain registration information required for the first authentication; and
a second authenticator configured to register the registration information as reference data used for the first authentication,
wherein the second authenticator uses the second authentication to register the reference data,
wherein the first authenticator performs the first authentication using the reference data registered by the second authenticator, and
wherein the first authenticator uses the first authentication to determine usage authorization of the aerosol generator.

4. The generation control apparatus of claim 1, further comprising:
an acquisition unit configured to obtain user's biometric information; and
a second authenticator configured to perform adult authentication using the biometric information,
wherein the second authenticator registers the biometric information as reference data of the first authentication when the adult authentication has been normally completed.

5. The generation control apparatus of claim 1, further comprising:
an acquisition unit mounted on the aerosol generator, and a second authenticator mounted on the aerosol generator,
wherein the acquisition unit acquires user's biometric information, and
wherein the second authenticator transmits the biometric information to the authentication server, and requests adult authentication of the biometric information from the authentication server.

6. The generation control apparatus of claim 1, further comprising:
an acquisition unit mounted on the aerosol generator, and a second authenticator mounted on the aerosol generator,
wherein the acquisition unit acquires user's biometric information,
further comprising:
a second communication module configured to communicate with a user's terminal via a wired or wireless communication network,
wherein the second authenticator allows communication between the second communication module and the terminal, only when a serial code individually assigned to the aerosol generator is input into the terminal,
wherein, when the communication between the second communication module and the terminal is permitted, the second authenticator transmits the biometric information through the second communication module to the terminal, and
wherein the second authenticator requests the terminal to perform adult authentication of the biometric information through an authentication server.

7. The generation control apparatus of claim 1, further comprising:
a fingerprint sensor configured to recognize a user's fingerprint,
wherein the first authenticator performs the first authentication using fingerprint information recognized by the fingerprint sensor at an end of a preset duration when detection of the fingerprint is continuously maintained for the preset duration.

8. The generation control apparatus of claim 1, further comprising:
a position detector configured to detect a current position of the aerosol generator,
wherein, when the determiner determines that the current position is included in a non-smoking area, the determiner suppresses an operation of the aerosol generator regardless of whether the first authentication is performed.

9. The generation control apparatus of claim 8, wherein the position detector is normally maintained in a state where supply of driving power is cut off,
wherein the first authenticator provides the driving power to the position detector, when the first authentication is normally performed, and
wherein the determiner permits the operation of the aerosol generator only when the current position detected by the position detector, which is supplied with the driving power, is outside the non-smoking area.

10. The generation control apparatus of claim 8, further comprising:
an operation unit operated manually by a user,
wherein, when operation suppression of the aerosol generator due to the current position being within the non-smoking area is defined as zone-based suppression, the operation unit forcibly releases the zone-based suppression through the manual operation, only when the first authentication is normally performed.

11. The generation control apparatus of claim 10, wherein the aerosol generator provides a smoke menu that allows selection between a smoke mode and a smokeless mode during aerosol generation, and
wherein the determiner sets the smoke menu to the smokeless mode regardless of a preset state of the smoke menu, when the zone-based suppression is forcibly released by the operation unit.

12. A generation control apparatus, comprising:
a first authenticator, a second authenticator, and a determiner mounted on an aerosol generator,
wherein the first authenticator performs first authentication,
wherein the second authenticator performs second authentication,
wherein the determiner distinguishes between a first mode in which the first authentication is performed and a second mode in which the second authentication is performed, based on a user's selection,
wherein, in the second mode, the determiner performs the second authentication and registers reference data used for the first authentication based on a result of the second authentication, and
wherein, in the first mode, the determiner performs the first authentication using the reference data.

13. The generation control apparatus of claim 12, wherein, if the second mode is selected while the reference data is not registered, the determiner immediately performs the second mode,
wherein, if the second mode is selected while the reference data has already been registered, the determiner first performs the first mode while deferring execution of the second mode, and
wherein the determiner performs the second mode when the first authentication is normally completed through execution of the first mode.

14. The generation control apparatus of claim 12, wherein, if the first mode is selected while the reference data is not registered, the determiner first performs the second mode while deferring execution of the first mode, and
wherein, if the reference data is registered through execution of the second mode, the determiner performs the first mode that is deferred.

15. A generation control method performed by a generation control apparatus, the method comprising:
an acquisition operation of acquiring first biometric information in a first mode for attempting smoking using an aerosol generator, and acquiring second biometric information in the second mode for registering a user;
a first authentication operation of performing registrant authentication by comparing the first biometric information with previously registered reference data, in the first mode;
a determination operation of permitting an operation of the aerosol generator when the registrant authentication is successful, in the first mode; and
a second authentication operation of performing adult authentication using the second biometric information, in the second mode, and registering the second biometric information as the reference data when the adult authentication is successful.
